(19) United States
(12) Patent Application Publication
(10) Pub. No.: US 2011/0051941 A1
(43) Pub. Date: Mar. 3, 2011

(54) MICROPHONE DIAGNOSTIC METHOD AND SYSTEM FOR ACCOMPLISHING THE SAME

(75) Inventor: Jesse T. Gratke, Royal Oak, MI (US)

(73) Assignee: GENERAL MOTORS COMPANY, Detroit, MI (US)

(21) Appl. No.: 12/550,931

(22) Filed: Aug. 31, 2009

(51) Int. Cl. H04B 1/00; H04R 29/00

(52) U.S. Cl. 381/58; 381/86

(57) ABSTRACT

A microphone diagnostic method and system for accomplishing the same are disclosed herein. The method includes generating an analog tone signal and receiving the analog tone signal at a microphone. Via a processor operatively associated with the microphone, the analog tone signal is converted into a digital tone signal and the digital tone signal is compared to a reference digital tone signal having a predetermined amplitude range and a predetermined frequency range associated therewith. The method further includes generating a diagnostic trouble code signal when the digital tone signal falls outside of the predetermined amplitude range, or determining that the microphone is functioning properly when the digital tone signal falls within the predetermined amplitude range.

### TECHNICAL FIELD

The present disclosure relates generally to microphone diagnostic methods and systems for accomplishing the same.

### BACKGROUND

Vehicles equipped with telematics systems often have associated therewith a microphone, which may be used by a vehicle occupant for inputting verbal or other auditory commands. The microphone often has a processor operatively connected thereto and configured to run one or more software programs related to the operation and/or functionality of the microphone. At least one of these programs may include a microphone detection or diagnostic routine to determine if the microphone is functioning properly.

### SUMMARY

A microphone diagnostic method includes generating an analog tone signal, receiving the analog tone signal at a microphone, and converting the analog tone signal into a digital tone signal. The analog tone signal is converted into the digital tone signal via a processor operatively associated with the microphone. The method further includes comparing the digital tone signal to a reference digital tone signal having associated therewith a predetermined amplitude range and a predetermined frequency range, and either i) generating a diagnostic trouble code signal when the digital tone signal falls outside of the predetermined amplitude range, or ii) determining that the microphone is functioning properly when the digital tone signal falls within the predetermined amplitude range. Also disclosed herein is a system for accomplishing the same.

### BRIEF DESCRIPTION OF THE DRAWINGS

Features and advantages of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic diagram depicting an example of a microphone diagnostic system;

FIG. 2 is a flow diagram depicting an example of a microphone diagnostic method including a primary detection method and a secondary detection method;

FIG. 3 is a schematic diagram depicting an example of a microphone detection circuit for use in examples of the diagnostic method disclosed herein;

FIG. 4 is a flow diagram depicting an example of the secondary detection method portion of the microphone diagnostic method;

FIG. 5 is a flow diagram depicting an example of the primary detection method portion of the microphone diagnostic method; and

FIG. 6 is a graph depicting a frequency response of a microphone powered in steps of voltage.

### DETAILED DESCRIPTION

Example(s) of the method and system disclosed herein may be used to determine whether a microphone is functioning properly, even if a diagnostic trouble code (DTC) is generated from an initial or primary diagnostic test. The primary diagnostic test includes passing a direct current (DC) signal through the microphone and measuring its voltage output. In some instances, the DC signal may be sensitive to various environmental conditions. Such environmental conditions may cause, for example, expanding and/or contracting of components of a preamplifier associated with the microphone (when exposed, e.g., to excessively high or low ambient temperatures) and/or changes to the microphone diaphragm (when exposed, e.g., to excessive vibration). Upon exposure to one or more of these environmental conditions, the voltage level of the DC signal may be deleteriously affected, and the microphone diagnostic program will generate the previously mentioned DTC. The DTC indicates that the microphone is faulty, even though the microphone is actually functioning properly.

In instances where a DTC is generated, the diagnostic method disclosed herein initiates a secondary diagnostic test that uses an analog signal (which is less sensitive (if not completely insensitive) to the environmental conditions mentioned above), and converts the analog signal to a digital signal to determine whether the previously generated DTC is faulty or accurate. Such determination may then be used to determine whether or not the microphone is truly functioning properly. The method and system disclosed herein advantageously reduce or possibly eliminate any false indications of an improperly functioning microphone, thereby substantially eliminating unnecessary maintenance and/or replacement of the part.

It is to be understood that, as used herein, the term “user” includes vehicle owners, operators, and/or passengers. It is to be further understood that the term “user” may be used interchangeably with subscriber/service subscriber.

The terms “connect/connected/connection” and/or the like are broadly defined herein to encompass a variety of divergent connected arrangements and assembly techniques. These arrangements and techniques include, but are not limited to (1) the direct communication between one component and another component with no intervening components therebetween; and (2) the communication of one component and another component with one or more components therebetween, provided that the one component being “connected to” the other component is somehow in operative communication with the other component (notwithstanding the presence of one or more additional components therebetween).

It is to be further understood that “communication” is to be construed to include all forms of communication, including direct and indirect communication. As such, indirect communication may include communication between two components with additional component(s) located therebetween.

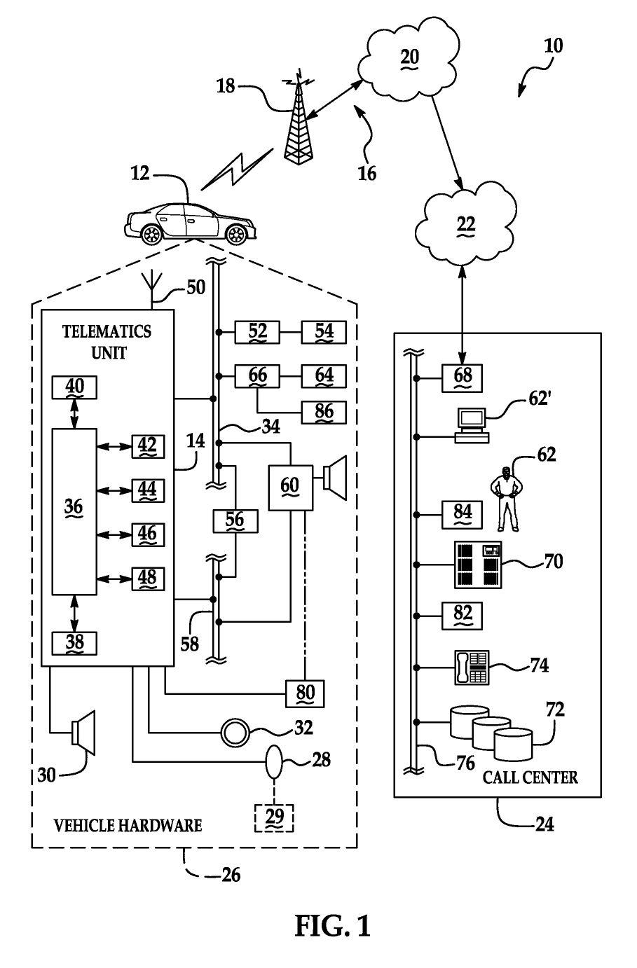

Referring now to FIG. 1, the system 10 includes a vehicle 12, a telematics unit 14, a wireless carrier/communication system 16 (including, but not limited to, one or more cell towers 18, one or more base stations and/or mobile switching centers (MSCs) 20, and one or more service providers (not shown)), one or more land networks 22, and one or more call centers 24. In an example, the wireless carrier/communication system 16 is a two-way radio frequency communication system.

The overall architecture, setup and operation, as well as many of the individual components of the system 10 shown in FIG. 1 are generally known in the art. Thus, the following paragraphs provide a brief overview of one example of such a system 10. It is to be understood, however, that additional components and/or other systems not shown here could employ the method(s) disclosed herein.

Vehicle 12 is a mobile vehicle such as a motorcycle, car, truck, recreational vehicle (RV), boat, plane, etc., and is equipped with suitable hardware and software that enables it to communicate (e.g., transmit and/or receive voice and data communications) over the wireless carrier/communication system 16. It is to be understood that the vehicle 12 may also include additional components suitable for use in the telematics unit 14.

Some of the vehicle hardware 26 is shown generally in FIG. 1, including the telematics unit 14 and other components that are operatively connected to the telematics unit 14. Examples of such other hardware 26 components include a microphone 28, a speaker 30 and buttons, knobs, switches, keyboards, and/or controls 32. Generally, these hardware 26 components enable a user to communicate with the telematics unit 14 and any other system 10 components in communication with the telematics unit 14.

Operatively coupled to the telematics unit 14 is a network connection or vehicle bus 34. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few. The vehicle bus 34 enables the vehicle 12 to send and receive signals from the telematics unit 14 to various units of equipment and systems both outside the vehicle 12 and within the vehicle 12 to perform various functions, such as unlocking a door, executing personal comfort settings, and/or the like.

The telematics unit 14 is an onboard device that provides a variety of services, both individually and through its communication with the call center 24. The telematics unit 14 generally includes an electronic processing device 36 operatively coupled to one or more types of electronic memory 38, a cellular chipset/component 40, a wireless modem 42, a navigation unit containing a location detection (e.g., global positioning system (GPS)) chipset/component 44, a real-time clock (RTC) 46, a short-range wireless communication network 48 (e.g., a BLUETOOTH® unit), and/or a dual antenna 50. In one example, the wireless modem 42 includes a computer program and/or set of software routines executing within processing device 36.

It is to be understood that the telematics unit 14 may be implemented without one or more of the above listed components, such as, for example, the short-range wireless communication network 48. It is to be further understood that telematics unit 14 may also include additional components and functionality as desired for a particular end use.

The electronic processing device 36 may be a micro controller, a controller, a microprocessor, a host processor, and/or a vehicle communications processor. In another example, electronic processing device 36 may be an application specific integrated circuit (ASIC). Alternatively, electronic processing device 36 may be a processor working in conjunction with a central processing unit (CPU) performing the function of a general-purpose processor.

The location detection chipset/component 44 may include a Global Position System (GPS) receiver, a radio triangulation system, a dead reckoning position system, and/or combinations thereof In particular, a GPS receiver provides accurate time and latitude and longitude coordinates of the vehicle 12 responsive to a GPS broadcast signal received from a GPS satellite constellation (not shown).

The cellular chipset/component 40 may be an analog, digital, dual-mode, dual-band, multi-mode and/or multi-band cellular phone. The cellular chipset-component 40 uses one or more prescribed frequencies in the 800 MHz analog band or in the 800 MHz, 900 MHz, 1900 MHz and higher digital cellular bands. Any suitable protocol may be used, including digital transmission technologies such as TDMA (time division multiple access), CDMA (code division multiple access) and GSM (global system for mobile telecommunications). In some instances, the protocol may be a short-range wireless communication technologies, such as BLUETOOTH®, dedicated short-range communications (DSRC), or Wi-Fi.

Also associated with electronic processing device 36 is the previously mentioned real time clock (RTC) 46, which provides accurate date and time information to the telematics unit 14 hardware and software components that may require and/or request such date and time information. In an example, the RTC 46 may provide date and time information periodically, such as, for example, every ten milliseconds.

The telematics unit 14 provides numerous services, some of which may not be listed herein, and is configured to fulfill one or more user or subscriber requests. Several examples of such services include, but are not limited to: turn-by-turn directions and other navigation-related services provided in conjunction with the GPS based chipset/component 44; airbag deployment notification and other emergency or roadside assistance-related services provided in connection with various crash and or collision sensor interface modules 52 and sensors 54 located throughout the vehicle 12; and infotainment-related services where music, Web pages, movies, television programs, videogames and/or other content is downloaded by an infotainment center 56 operatively connected to the telematics unit 14 via vehicle bus 34 and audio bus 58. In one non-limiting example, downloaded content is stored (e.g., in memory 38) for current or later playback.

Again, the above-listed services are by no means an exhaustive list of all the capabilities of telematics unit 14, but are simply an illustration of some of the services that the telematics unit 14 is capable of offering.

The telematics unit 14 may further be configured to generate an analog tone signal for examples of the microphone diagnostic method disclosed herein. In an example, the telematics unit 14, via the electronic memory 38 operatively associated therewith, may have a plurality of analog tone signals stored therein, where each analog tone signal has a different frequency (measured, e.g., in Hz). The telematics unit 14, via at least one software program operated by the electronic processing device 36 (also referred to herein as the processor 36), is further configured to retrieve one of the analog tone signals stored in the memory 38 to generate an analog tone signal for use in examples of the diagnostic method described herein.

Vehicle communications generally utilize radio transmissions to establish a voice channel with wireless carrier system 16 such that both voice and data transmissions may be sent and received over the voice channel. Vehicle communications are enabled via the cellular chipset/component 40 for voice communications and the wireless modem 42 for data transmission. In order to enable successful data transmission over the voice channel, wireless modem 42 applies some type of encoding or modulation to convert the digital data so that it can communicate through a vocoder or speech codec incorporated in the cellular chipset/component 40. It is to be understood that any suitable encoding or modulation technique that provides an acceptable data rate and bit error may be used with the examples disclosed herein. Generally, dual mode antenna 50 services the location detection chipset/component 44 and the cellular chipset/component 40.

Microphone 28 provides the user with a means for inputting verbal or other auditory commands, and can be equipped with an embedded voice processing unit utilizing human/machine interface (HMI) technology known in the art. The microphone 28 is also configured to receive an analog tone signal from the telematics unit 14 and/or from the call center 24 according to one or more examples of the diagnostic method described below. Conversely, speaker 30 provides verbal output to the vehicle occupants and can be either a stand-alone speaker specifically dedicated for use with the telematics unit 14 or can be part of a vehicle audio component 60. In either event and as previously mentioned, microphone 28 and speaker 30 enable vehicle hardware 26 and call center 24 to communicate with the occupants through audible speech. The vehicle hardware 26 also includes one or more buttons, knobs, switches, keyboards, and/or controls 32 for enabling a vehicle occupant to activate or engage one or more of the vehicle hardware components. In one example, one of the buttons 32 may be an electronic pushbutton used to initiate voice communication with the call center 24 (whether it be a live advisor 62 or an automated call response system 62′). In another example, one of the buttons 32 may be used to initiate emergency services.

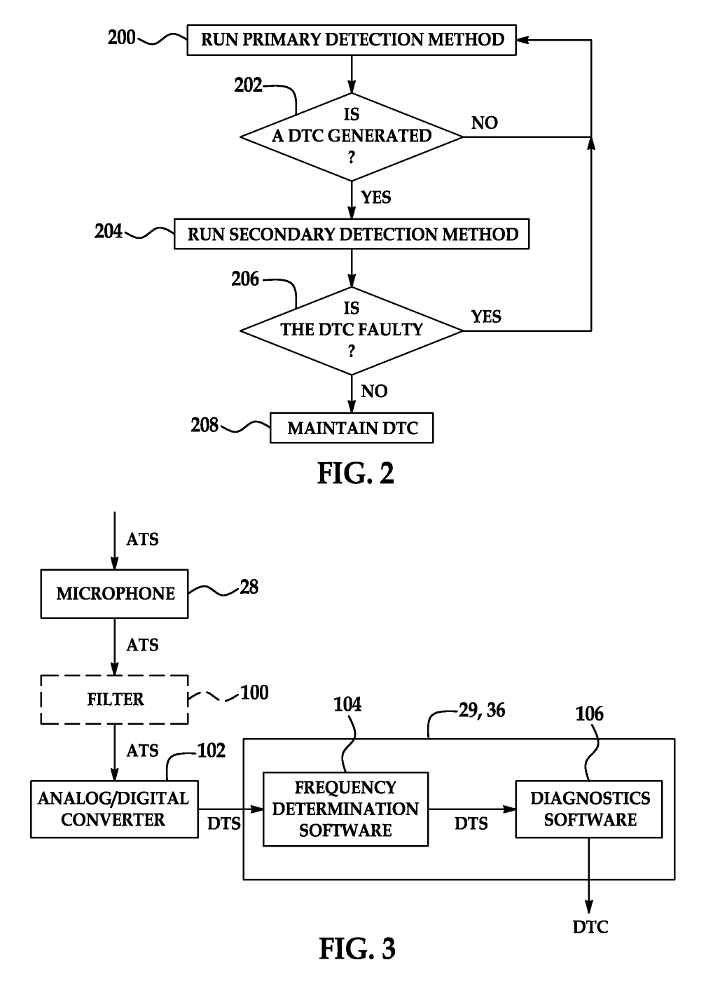

It is to be understood that the electronic processing device 36 may further be configured to run one or more software programs including computer readable code for performing one or more steps of examples of the diagnostic method disclosed herein. The steps of the diagnostic method will be described in further detail below in conjunction with FIGS. 2-6. However, in instances where the electronic processing device 36 does not have associated therewith enough available memory, hardware terminals, and/or the like for performing one or more of the steps of the method, another electronic processor (such as the electronic processor 29 shown in FIG. 1) may also be used. This other electronic processor 29 may, in an example, be selectively and operatively associated with the microphone 28 and may be configured to run the software program(s) including the computer readable code for performing the method steps of the instant disclosure.

The audio component 60 is operatively connected to the vehicle bus 34 and the audio bus 58. The audio component 60 receives analog information (such as, e.g., an analog tone signal from the telematics unit 14 and/or the call center 24), rendering it as sound, via the audio bus 58. Digital information is received via the vehicle bus 34. The audio component 60 provides AM and FM radio, satellite radio, CD, DVD, multimedia and other like functionality independent of the infotainment center 56. Audio component 60 may contain a speaker system, or may utilize speaker 30 via arbitration on vehicle bus 34 and/or audio bus 58.

The vehicle crash and/or collision detection sensor interface 52 is/are operatively connected to the vehicle bus 34. The crash sensors 54 provide information to the telematics unit 14 via the crash and/or collision detection sensor interface 52 regarding the severity of a vehicle collision, such as the angle of impact and the amount of force sustained.

Other vehicle sensors 64, connected to various sensor interface modules 66 are operatively connected to the vehicle bus 34. Example vehicle sensors 64 include, but are not limited to, gyroscopes, accelerometers, magnetometers, emission detection and/or control sensors, environmental detection sensors, and/or the like. One or more of the sensors 64 enumerated above may be used to obtain the vehicle data for use by the telematics unit 14 or the call center 24 to determine the operation of the vehicle 12. Non-limiting example sensor interface modules 66 include powertrain control, climate control, body control, and/or the like.

In a non-limiting example, the vehicle hardware 26 includes a display 80, which may be operatively directly connected to or in communication with the telematics unit 14, or may be part of the audio component 60. Non-limiting examples of the display 80 include a VFD (Vacuum Fluorescent Display), an LED (Light Emitting Diode) display, a driver information center display, a radio display, an arbitrary text device, a heads-up display (HUD), an LCD (Liquid Crystal Diode) display, and/or the like.

Wireless carrier/communication system 16 may be a cellular telephone system or any other suitable wireless system that transmits signals between the vehicle hardware 26 and land network 22. According to an example, wireless carrier/communication system 16 includes one or more cell towers 18, base stations and/or mobile switching centers (MSCs) 20, as well as any other networking components required to connect the wireless system 16 with land network 22. It is to be understood that various cell tower/base station/MSC arrangements are possible and could be used with wireless system 16. For example, a base station 20 and a cell tower 18 may be co-located at the same site or they could be remotely located, and a single base station 20 may be coupled to various cell towers 18 or various base stations 20 could be coupled with a single MSC 20. A speech codec or vocoder may also be incorporated in one or more of the base stations 20, but depending on the particular architecture of the wireless network 16, it could be incorporated within a Mobile Switching Center 20 or some other network components as well.

Land network 22 may be a conventional land-based telecommunications network that is connected to one or more landline telephones and connects wireless carrier/communication network 16 to call center 24. For example, land network 22 may include a public switched telephone network (PSTN) and/or an Internet protocol (IP) network. It is to be understood that one or more segments of the land network 22 may be implemented in the form of a standard wired network, a fiber of other optical network, a cable network, other wireless networks such as wireless local networks (WLANs) or networks providing broadband wireless access (BWA), or any combination thereof.

Call center 24 is designed to provide the vehicle hardware 26 with a number of different system back-end functions. According to the example shown here, the call center 24 generally includes one or more switches 68, servers 70, databases 72, live and/or automated advisors 62, 62′, a processor 84, as well as a variety of other telecommunication and computer equipment 74 that is known to those skilled in the art. For example, such equipment 74 may be configured to transmit information (such as, e.g., a diagnostic trouble code) to the telematics unit 14 in instances where the microphone 28 is considered to be functioning improperly, according to some examples of the method disclosed herein. These various call center components are coupled to one another via a network connection or bus 76, such as one similar to the vehicle bus 34 previously described in connection with the vehicle hardware 26.

The processor 84, which is often used in conjunction with the computer equipment 74, is generally equipped with suitable software and/or programs configured to accomplish a variety of call center 24 functions. In an example, the processor 84 uses at least some of the software programs to perform one or more steps of examples of the diagnostic method disclosed herein. Such steps will also be described hereinbelow also in conjunction with FIGS. 2-6.

The live advisor 62 may be physically present at the call center 24 or may be located remote from the call center 24 while communicating therethrough.

Switch 68, which may be a private branch exchange (PBX) switch, routes incoming signals so that voice transmissions are usually sent to either the live advisor 62 or the automated response system 62′, and data transmissions are passed on to a modem or other piece of equipment (not shown) for demodulation and further signal processing. The modem preferably includes an encoder, as previously explained, and can be connected to various devices such as the server 70 and database 72. For example, database 72 may be designed to store subscriber profile records, subscriber behavioral patterns, or any other pertinent subscriber information. Although the illustrated example has been described as it would be used in conjunction with a manned call center 24, it is to be appreciated that the call center 24 may be any central or remote facility, manned or unmanned, mobile or fixed, to or from which it is desirable to exchange voice and data communications.

A cellular service provider generally owns and/or operates the wireless carrier/communication system 16. It is to be understood that, although the cellular service provider (not shown) may be located at the call center 24, the call center 24 is a separate and distinct entity from the cellular service provider. In an example, the cellular service provider is located remote from the call center 24. A cellular service provider provides the user with telephone and/or Internet services, while the call center 24 is a telematics service provider. The cellular service provider is generally a wireless carrier (such as, for example, Verizon Wireless®, AT&T®, Sprint®, etc.). It is to be understood that the cellular service provider may interact with the call center 24 to provide various service(s) to the user.

As stated above, examples of the microphone diagnostic method will be described hereinbelow in conjunction with FIGS. 2-6. As a general overview, the flow diagram depicted in FIG. 2 sets forth an example of the diagnostic method that uses a primary detection method and a secondary detection method. As will be described in further detail below, the primary detection method may be any known detection method that is capable of generating a diagnostic trouble code (DTC) upon detecting that the microphone 28 may be functioning improperly. Details of one example of the primary detection method are described below in conjunction with FIGS. 2 and 5. The secondary detection method is generally used to verify that a DTC generated by the primary detection method does in fact reflect that the microphone 28 is malfunctioning. Details of an example of the secondary detection method are described below in conjunction with FIGS. 2, 4, and 6. The examples of the diagnostic method are also described below with reference to the diagnostic system 10 depicted in FIG. 1, as well as with reference to a microphone detection circuit schematically depicted in FIG. 3.

It is to be understood that the examples of the diagnostic method disclosed hereinabove are typically accomplished using an activated microphone 28. In some cases, the microphone 28 is inactive until it is activated, e.g., in response to a physical trigger such as, for instance, a button press to initiate communication between the telematics unit 14 and the call center 24, or another entity. Such communication is often accomplished by the user of the vehicle 12. In other cases, the microphone 28 is activated as soon as the vehicle 12 is started (i.e., an ignition on cycle) and/or as soon as the telematics unit 14 is activated. In yet other cases, the telematics unit 14 and the microphone 28 are always in an active state regardless of whether the vehicle 12 is operating or not. It is further to be understood that the diagnostic method is typically available (assuming that there are no internal problems associated with the diagnostic system itself that would render the system inoperable) even if the microphone 28 is in an inactive state. This is due, at least in part, to the fact that the microphone 28 (even in an inactive state) is powered by the telematics unit 14. In this case, the diagnostic method runs in the background to determine whether or not a microphone 28 is actually present, and if so, whether or not the microphone 28 is functioning properly.

Referring now specifically to FIG. 2, an example of the microphone detection method includes running a primary detection method to determine if the microphone 28 might be functioning improperly (as shown by reference numeral 200). As used herein, the term “primary detection method” refers to a detection method that may be used to render an initial determination as to whether or not the microphone 28 is functioning improperly. Many examples of suitable primary detection methods are generally known to those skilled in the art, and at least some of these methods may be used in the microphone diagnostic method disclosed herein. One example of the primary detection method is generally known as a voltage or load test. Such example is generally depicted in FIG. 5.

With reference to FIGS. 2 and 5 together, the primary detection method includes passing a DC signal through the microphone 28 and checking a voltage output of the microphone 28 (as shown by reference numerals 500 and 502 in FIG. 5). Checking may be accomplished, e.g., using the telematics circuitry. In an example, the output voltage level or gain of the microphone 28 may be checked and/or measured periodically such as, e.g., every second (or some other time interval) for as long as the microphone 28 is powered on. If, for example, the voltage output of the microphone 28 exceeds a predetermined threshold value, the microphone 28 is considered to be functioning properly and the primary detection method is repeated. However, in instances where the output voltage of the microphone 28 falls below the predetermined threshold value (i.e., an open circuit is detected) or has no voltage output (i.e., a short circuit is detected), a DTC signal or an error message is generated indicating a potential problem with the functionality of the microphone 28 (as shown by reference numerals 504 and 506). A DTC signal or an error message may also be generated when the output voltage is over the upper limit of the predetermined threshold. It is to be understood that the predetermined threshold value will be determined by the system hardware requirements (e.g., the type of microphone 28 used, the vendor of the microphone 28, etc.), and as such may vary from vehicle 12 to vehicle 12. In many instances, the predetermined threshold value is determined through a manual validation process, and thus, as previously mentioned, will vary from microphone 28 to microphone 28.

Once the DTC signal or the error message is generated, the processor 36 (and/or the processor 29) may, in an example, determine that the microphone 28 is malfunctioning. In this case, the secondary detection method may be initiated to determine if the DTC signal or the error message is accurate. In another example, the primary detection method may be re-applied for one or more iterations to see if the DTC signal or error message is repeatedly generated. For instance, the processor 36 (and/or the processor 29) monitors the output voltage of the microphone 28 for subsequent iterations using the telematics circuitry. If a pre-selected number (e.g., one or two) of the subsequent iterations have an output voltage measurement that falls outside (i.e., is above or below) the predetermined threshold value or if there is no voltage at all, the DTC is maintained. If, on the other hand, none of the pre-selected number of subsequent iterations has an output voltage measurement that falls outside the predetermined threshold value (i.e., a suitable voltage is measured), the original DTC signal is cleared and the microphone 28 is considered to be functioning properly.

As stated above, certain environmental conditions (such as, e.g., extreme temperature conditions, vibrations, or the like) may cause the output voltage of the microphone 28 to artificially fall outside the predetermined threshold value, thereby producing a faulty DTC. However, the inventors of the instant disclosure have unexpectedly and fortuitously discovered that such environmental conditions do not have the same affect on analog signals. Thus, a secondary detection method may be applied that includes passing an analog tone signal through the microphone 28, converting the analog tone signal into a digital tone signal, and then running a secondary diagnostic test on the digital tone signal. The secondary detection method advantageously reduces or even substantially eliminates faulty DTCs generated from the primary detection method. The conversion of the analog tone signal and the secondary detection method will now be described in conjunction with FIGS. 2-4 and 6.

Referring back to FIG. 2, if the primary detection method run in step 200 does not produce a DTC (as shown by reference numeral 202 in FIG. 2), the method loops back and the primary detection method is re-run. Such looping may be accomplished periodically such as, e.g., every second, until the microphone 28 is powered off or a DTC is generated. As such, in most instances, the primary detection method continues to run in the background while the microphone 28 is in its operable/powered state. Although generally not the case, in other instances the looping may time out after a predefined amount of time so long as no DTCs are generated using the primary detection method. In another example, the primary detection method shuts down for so long as the microphone 28 is activated. In this example, if the user subsequently recognizes or believes that the active microphone 28 is malfunctioning, he/she may request that the primary diagnostic method be re-run. It is to be understood that the user may request that the secondary diagnostic method be run. This scenario is likely when the user believes that the microphone 28 is having problems.

In instances where a DTC is not generated, the microphone 28 is considered to be functioning properly and normal microphone operations are continued.

In instances where a DTC is generated from the primary detection method, the method further includes running a secondary detection method (as shown by reference numeral 204 in FIG. 2). As used herein, the term “secondary detection method” refers to a microphone detection method that occurs after the primary detection method generates one or more DTCs indicating that the microphone 28 may be malfunctioning. In other words, the secondary detection method is generally used to verify accuracy of the DTC(s) generated during the primary detection method. As shown by the method step depicted at reference numeral 206 in FIG. 2, if the results of the secondary detection method indicate that the DTC generated during the primary detection method is faulty, the DTC is cleared and the entire diagnostic method starts over again (i.e., starting with the primary detection method).

If, on the other hand, the secondary detection method determines that the DTC is in fact accurate, then the DTC is maintained (as shown by reference numeral 208 in FIG. 2). At this point, the vehicle user and/or the call center 24 may be notified that the microphone 28 is in fact functioning improperly and requires maintenance and/or replacement. Notification may be accomplished via the on-board telematics unit 14, which automatically contacts the call center 24 (by transmitting a data message) as soon as the DTC is verified. Notification to the call center 24 may otherwise be accomplished manually by the user of the microphone 28 after the user is alerted that the microphone 28 is malfunctioning. The user may be alerted of the problem via, e.g., an audible alert (e.g., a beep or an automated verbal warning) and/or a visual alert (e.g., a text warning, a red light, or the like provided on the display 80). The alert may be generated by the processor 36 and/or 29 upon determining (via the secondary detection method) that the DTC generated by the primary detection method is accurate. The user may then contact the call center 24 via a cellular phone call or some other like means of communication (except for the microphone 28, which is not functioning properly).

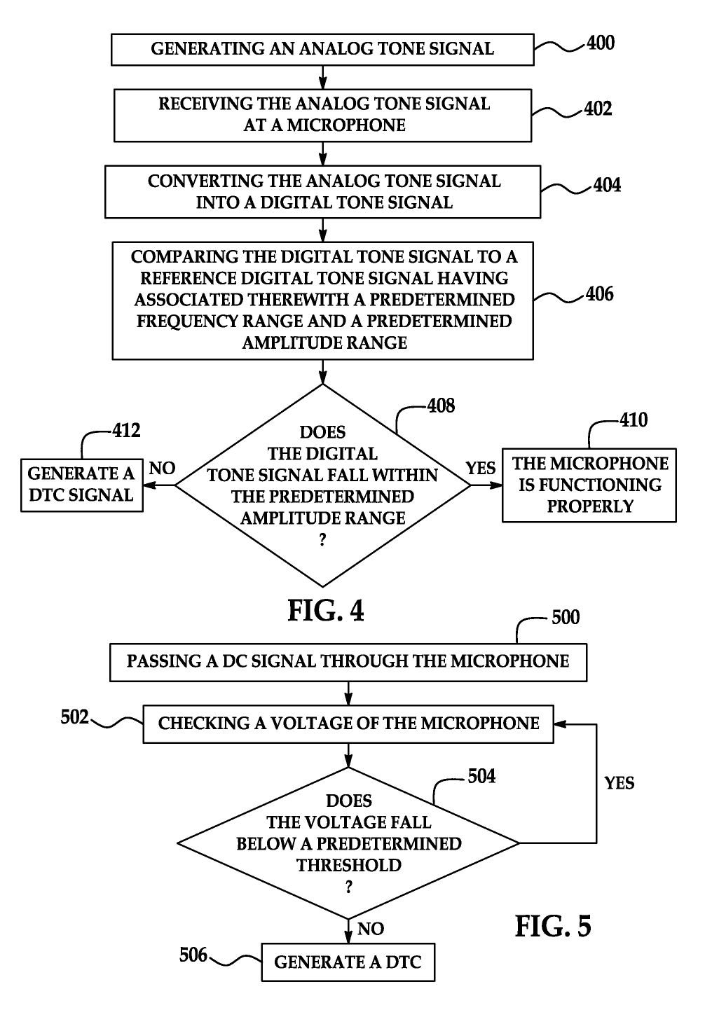

Referring now to FIGS. 3, 4, and 6, when a DTC or an error message is generated and/or obtained as a result of the primary detection method, the secondary detection method begins. During the secondary detection method, an analog tone signal ATS is generated (as shown by reference numeral 400 in FIG. 4). As will be discussed further herein, the ATS may be “generated” by i) retrieving the signal which is resonant on the telematics unit 14, ii) downloading the signal to the telematics unit 14 (e.g., from the call center 24), and iii) receiving the signal in a continuous stream in the form of packet data (e.g., from the call center 24). The analog tone signal ATS may be, e.g., a swept sine wave tone signal, white noise, a spoken speech pattern, or combinations thereof, where the analog tone signal ATS includes a broadband of frequencies, which at least vary, e.g., from about 0 kHz to about 10 kHz. It is to be understood that the broadband of frequencies covered by the ATS may range from 0 kHz up to any desirable frequency, but it is generally desirable that the range at least include those within the human audible frequency range (e.g., from 16 Hz to 16000 Hz).

In an example, the generating of the analog tone signal ATS may be accomplished by the call center 24. In one case, upon receiving an error message that the microphone 28 is functioning improperly, the user of the microphone 28 contacts the call center 24 (via, e.g., a phone call, a button press using the telematics unit 14, or other suitable means) and requests that the call center 24 send the analog tone signal ATS. It is to be understood that since the microphone issues may prevent a user from speaking through the microphone 28, the call may be accompanied with a data message that would inform the advisor 62, 62′ at the call center 24 that the microphone 28 may be malfunctioning and to initiate the diagnostic method. In response to the request, the call center 24 generates the analog tone signal ATS and sends it to the telematics unit 14 or directly to the vehicle audio component 60. In an example, the analog tone signal ATS is sent alone as a signal transmission by the call center 24 (i.e., the ATS is downloaded to the telematics unit 14). In another example, the analog tone signal ATS is sent from the call center 24 in the form of packet data (which may, for example, be sent as a continuous stream to the vehicle 12). In instances where the analog tone signal ATS is sent to the telematics unit 14, the telematics unit 14 automatically sends the analog tone signal ATS to the audio component 60. The audio component 60 plays the analog tone signal ATS generated by the call center 24, which is received by the microphone 28 (as shown by reference numeral 402 in FIG. 4).

It is to be understood that the analog tone signal ATS is generally played at a nominal listening level that is comfortable for the user, but at a level that will not distort the signal. Accordingly, the analog tone signal ATS may be played by at any suitable decibel level falling within these foregoing conditions. It is further to be understood that the nominal listening level may be calibrated during manufacturing of the vehicle 12.

In another example, an analog tone signal may be stored (e.g., as a wave file, MP3 file, or another audio file) in the memory 36 operatively associated with the telematics unit 14, where the stored analog tone signal covers the broadband frequency range described herein. In this example, when an error message is obtained that the microphone 28 is or may be malfunctioning, the analog tone signal is retrieved from the telematics unit 14. The retrieved analog tone signal may then be sent from the telematics unit 14 to the audio component 60.

In an example, the generated analog tone signal ATS passes through the microphone 28 and, in some instances, into a low pass sound filter 100 (shown in FIG. 3) before being played by the audio component 60. The low pass sound filter 100 filters the analog tone signal ATS to remove any frequencies that are above a predefined threshold. Similarly, a high pass filter (not shown) may be used to remove any frequencies that are below a predefined threshold. In still another example, the generated analog tone signal ATS passes into a band pass filter, which filters the analog tone signal ATS to remove any frequencies that are both above a predefined threshold and below another predefined threshold. In any of the examples provided herein, the removal of the high (i.e., above the threshold) and/or low (below the threshold) frequency/ies from the analog tone signal ATS results in an analog tone signal having a considerably more rounded sound than before such filtering. It is to be understood that filtering may be desirable when the original ATS covers a broadband frequency range, the outer limits of which extend well beyond the human audible frequency range. In this example, filtering would narrow the frequency range of the ATS to a desirable range (e.g., the human audible frequency range) for further testing.

After the analog tone signal ATS is generated (and, in some instances, filtered), the analog tone signal ATS is converted into a digital tone signal DTS (as shown by reference numeral 404 in FIG. 4). The conversion may be accomplished, for example, on command by the processor 36 and/or 29 operatively associated with the microphone 28. More specifically, the analog tone signal ATS passes through an analog/digital converter 102 (which is operatively associated with the processor 36 or processor 29), where the converter 102 runs a compression/decompression routine (also referred to as a CODEC program) that converts the analog tone signal ATS into the digital tone signal DTS.

After the analog tone signal ATS has been converted into the digital tone signal DTS, the digital tone signal DTS is compared to a reference digital tone signal having associated therewith a predetermined amplitude (measured, e.g., in decibels) and a predetermined frequency range (measured, e.g., in Hertz) (as shown by reference numeral 406 in FIG. 4). Using the frequency determination software (identified by reference numeral 104 in FIG. 3), the digital tone signal DTS may be placed into the frequency domain by applying a Fast Fourier transform (FFT) function on the signal. Generally, the FFT function is an algorithm, run by the processor 36 and/or 29, that computes a discrete Fourier transform (i.e., a function used to decompose a sequence of values into components of different frequencies) and the inverse thereof quickly and efficiently. The digital tone signal DTS, now in terms of frequency, may be compared to the reference digital tone signal to ultimately determine if the microphone 28 is in fact malfunctioning.

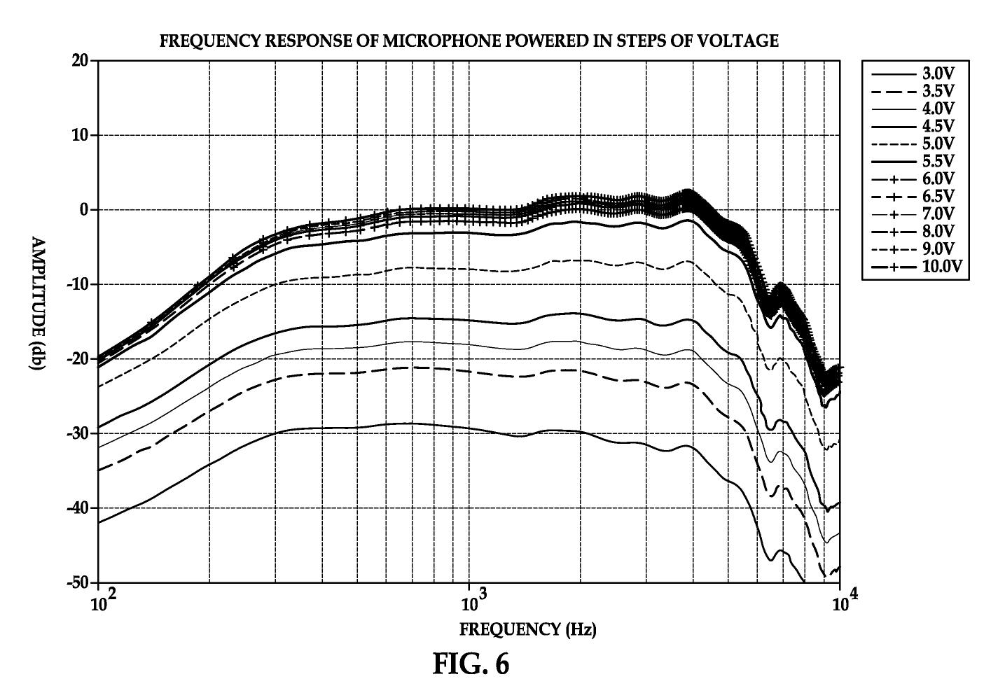

The reference digital tone signal DTS_{ref} may be determined using a normalized frequency response curve of the microphone 28 powered in terms of voltage. An example of such a normalized frequency response curve is shown in FIG. 6, where the frequency (in Hertz) of the digital tone signal is plotted against the amplitude (measured in terms of decibels (dB)) for a number of different voltages of the microphone 28. In a non-limiting example, the predetermined frequency range ranges from about 1×10² Hz to about 1×10⁴ Hz. Furthermore, the predetermined amplitude range falls within, e.g., 5 dB above and below the sound level of the microphone 28 powered at a particular voltage. It is to be understood, however, that the amplitude range may change depending, at least in part, on operating conditions of the vehicle 12, noise level inside the vehicle 12, etc. For instance, a digital tone signal DTS having a frequency of about 1×10³ Hz (which is within the frequency range of about 1×10² Hz to about 1×10⁴) for a microphone 28 powered at 10V may have, an amplitude range of about +5 dB to about −5 dB.

In an example, the processor 36 and/or 29 further includes diagnostics software (identified by reference numeral 106 in FIG. 3), which compares the digital tone signal DTS and the reference digital tone signal DTS_{ref}, both of which are now provided in the frequency domain due to the frequency determination software 104 (shown in FIG. 3). In an example, the amplitude (dB) of the digital tone signal DTS at, e.g., 1×10³ Hz is compared with that of the reference digital tone signal DTS_{ref} for the voltage at which the microphone 28 is powered (such as, e.g., 10V). The comparing may be accomplished, for example, using Equation (1):

20×abs[log(10)(DTS)−log(10)(DTS_{ref})]<5 dB Equation (1)

It is to be understood that the amplitudes at any frequency may be compared, but it is generally desirable to compare the amplitudes at 1×10³ Hz.

Referring back to FIG. 4, the method further includes determining whether or not the digital tone signal DTS falls within the predetermined amplitude range (for instance, between +5 dB and −5 dB according to the example described immediately above) (as shown by reference numeral 408 in FIG. 4). If, for example, the digital tone signal DTS falls within the predetermined amplitude range, then the microphone 28 is considered to be functioning properly (as shown by reference numeral 410 in FIG. 4). In this example, the DTC is cleared and/or reset.

If, on the other hand, the digital tone signal DTS does falls outside of the predetermined amplitude range, another DTC is generated (as shown by reference numeral 412 in FIG. 4). It is to be understood that, in some cases, the DTC generated using the secondary detection method verifies that the microphone 28 is in fact functioning improperly. However, in other cases, the secondary detection method may be repeated one or more additional times and, if a DTC is still generated after the repeated loops of the secondary detection method, then the microphone 28 is considered to be functioning improperly. In cases where the secondary detection method is repeated for one or more additional loops (referred to herein as a continuous loop process), such continuous loop process may occur until the digital tone signal DTS actually falls within the predetermined amplitude range and/or until a predetermined number of loops have been completed (such as, e.g., two or three loops). In instances where after the predetermined number of loops has been completed and a DTC is not generated, then the microphone 28 is considered to be functioning properly and the DTC generated from the primary detection method is cleared and/or reset.

In another example, after the analog tone signal ATS has been converted into the digital tone signal DTS, the digital tone signal DTS is sent, via the telematics unit 14, to the call center 24. Using one or more suitable software routines applying the method described hereinabove, the call center 24 compares the digital tone signal DTS with the reference digital tone signal DTS_{ref} to determine if the DTC generated during the primary detection method is accurate. In instances where another DTC is generated based on the comparison, the call center 24 may, in an example, ask the user of the vehicle 12 is he/she would like to have the microphone 28 services and/or replaced. In some cases, the call center 24 may also provide recommendations for operating the microphone 28 to see if performance of the microphone 28 improves. For example, the call center 24 may recommend to the user to lower the noise level of the vehicle 12 by, e.g., closing windows, turning down the air conditioning system, asking other passengers of the vehicle 12 to be quiet, and/or the like.

In another example, the call center 24 may send a signal back to the telematics unit 14 indicating that another iteration of the diagnostic method should be performed in order to verify the DTC. It is to be understood that the call center 24 may also be configured to perform one or more additional steps of the diagnostic method disclosed herein, including, but not limited to the comparing of the digital tone signal DTS with the reference digital tone signal DTS_{ref}. For instance, the call center 24 may also be configured to receive the other analog tone signal STS, convert the other analog tone signal ATS into the digital tone signal DTS and use the digital tone signal DTS to make the comparison with the reference digital tone signal DTS_{ref}.

The several examples of the diagnostic method disclosed herein use the primary detection method and, if a DTC is generated, the secondary detection method to determine if the microphone 28 is actually malfunctioning. It is to be understood, however, that the diagnostic method may otherwise only use the secondary detection method to accomplish the same. For instance, the secondary detection method may be used to initially generate a DTC and, depending on how the diagnostic system is configured, to verify the accuracy of the DTC using one or more iterations of the secondary detection method.

While several examples have been described in detail, it will be apparent to those skilled in the art that the disclosed examples may be modified. Therefore, the foregoing description is to be considered exemplary rather than limiting.

1. A microphone diagnostic method, comprising:
generating an analog tone signal;
receiving the analog tone signal at a microphone;
converting, via a processor operatively associated with the microphone, the analog tone signal into a digital tone signal;
comparing the digital tone signal to a reference digital tone signal having associated therewith a predetermined amplitude range and a predetermined frequency range; and
i) generating a diagnostic trouble code signal when the digital tone signal falls outside of the predetermined amplitude range, or ii) determining that the microphone is functioning properly when the digital tone signal falls within the predetermined amplitude range.

2. The method as defined in claim 1 wherein the microphone is operatively disposed in a vehicle, and wherein prior to generating the analog tone signal, the method further comprises:
obtaining at least one of an error message or a diagnostic trouble code that the microphone is malfunctioning; and
requesting, from a call center, to generate the analog tone signal.

3. The method as defined in claim 2, further comprising sending the generated analog tone signal from the call center to i) a telematics unit operatively disposed in the vehicle, or ii) a vehicle audio component operatively disposed in the vehicle.

4. The method as defined in claim 1 wherein prior to generating the analog tone signal, the method further comprises:
storing a plurality of analog tone signals in a telematics unit operatively disposed in a vehicle, the plurality of analog tone signals having different frequencies;
obtaining an error message that the microphone is malfunctioning; and
retrieving one of the plurality of analog tone signals from the telematics unit.

5. The method as defined in claim 4, further comprising sending the retrieved analog tone signal from the telematics unit to a vehicle audio component.

6. The method as defined in claim 1 wherein the analog tone signal is a swept sine wave tone signal, a white noise signal, a spoken speech pattern, or combinations thereof.

7. The method as defined in claim 1 wherein after the converting, the method further includes applying a fast Fourier transform function on the digital tone signal to determine a frequency of the digital tone signal.

8. The method as defined in claim 7 wherein determining that the microphone is functioning properly includes determining that the amplitude of the digital tone signal falls within the predetermined amplitude range, and wherein the method further comprises re-setting the diagnostic trouble code signal.

9. The method as defined in claim 1 wherein when the diagnostic trouble code signal is generated, the method further comprises repeating the converting, the comparing, and the generating as a continuous loop process until i) the digital tone signal falls within the predetermined amplitude range, ii) a predetermined number of loops have been completed, or iii) combinations thereof.

10. The method as defined in claim 1 wherein the comparing of the digital tone signal and the generating of the diagnostic trouble code signal is accomplished via the processor operatively associated with microphone.

11. The method as defined in claim 10 wherein prior to comparing the digital tone signal to the reference digital tone signal, the method further comprises sending the digital tone signal to a call center, and wherein the comparing of the digital tone signal and the generating of the diagnostic trouble code signal is accomplished at the call center.

12. A microphone diagnostic system, comprising:
means for generating an analog tone signal;
a microphone configured to receive the analog tone signal; and
a processor operatively associated with the microphone, the processor including:
computer readable code for converting the analog tone signal into a digital tone signal;
computer readable code for comparing the digital tone signal to a reference tone signal having associated therewith a predetermined amplitude range and a predetermined frequency range; and
computer readable code for generating a diagnostic trouble code when the digital tone signal falls outside of the predetermined amplitude range.

13. The system as defined in claim 12 wherein the means for generating the analog tone signal includes a call center, a telematics unit, or combinations thereof

14. The system as defined in claim 13, further comprising a vehicle audio component operatively associated with the telematics unit, the vehicle audio component configured to receive the generated analog tone signal from at least one of the telematics unit or the call center.

15. The system as defined in claim 13 wherein the telematics unit includes a plurality of stored analog tone signals, and wherein the telematics unit is configured to retrieve one of the plurality of stored analog tone signals to generate the analog tone signal.

16. The system as defined in claim 12 wherein the processor further includes computer readable code for applying a fast Fourier transform function on the digital tone signal for determining a frequency of the digital tone signal.

17. A microphone diagnostic system, comprising:
means for generating an analog tone signal;
a microphone configured to receive the analog tone signal, the microphone having associated therewith a processor including computer readable code for converting the analog tone signal into a digital tone signal;
a telematics unit operatively connected to the microphone and configured to receive the digital tone signal therefrom; and
a call center in selective operative communication with the telematics unit, the call center having associated therewith an other processor configured to receive the digital tone signal from the telematics unit, the other processor including:
computer readable code for comparing the digital tone signal to a reference tone signal having associated therewith a predetermined amplitude range and a predetermined frequency range; and
computer readable code for generating a diagnostic trouble code when the digital tone signal falls outside of the predetermined amplitude range.

18. The system as defined in claim 17 wherein the call center further includes means for transmitting the diagnostic trouble code to the telematics unit when the digital tone signal falls outside of the predetermined amplitude range.

19. The system as defined in claim 17 wherein the other processor further includes computer readable code for applying a fast Fourier transform function on the digital tone signal for determining a frequency of the digital tone signal.

20. The system as defined in claim 17 wherein the means for generating the analog tone signal includes the call center, the telematics unit, or a combination thereof, and wherein the system further comprises a vehicle audio component operatively associated with the telematics unit, the vehicle audio component configured to receive the generated analog tone signal from at least one of the telematics unit or the call center.
